(19) United States
(12) Patent Application Publication
(10) Pub. No.: US 2007/0232293 A1
(43) Pub. Date: Oct. 4, 2007

(54) APPARATUS AND METHOD FOR PROVIDING INTEROPERABILITY BETWEEN MOBILE RADIO SERVICES

(75) Inventors: Stuart O. Goldman, Scottsdale, AZ (US); Richard E. Krock, Naperville, IL (US); Karl F. Rauscher, Emmaus, PA (US); James P. Runyon, Wheaton, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc., Murray Hill, NJ (US)

(21) Appl. No.: 11/278,630

(22) Filed: Apr. 4, 2006

(51) Int. Cl. H04Q 7/20

(52) U.S. Cl. 455/426.1; 370/338

(57) ABSTRACT

A method of bridging mobile radio services includes: establishing communication with a first portable two-way radio via a first mobile radio service; receiving traffic from the first portable two-way radio via the first mobile radio service; converting the received traffic into a designated format; and, routing the traffic to a selected destination.

### FIELD

The present inventive subject matter relates to the telecommunication arts. One particular application is found in conjunction with Specialized Mobile Radio (SMR) services, and the specification makes particular reference thereto. However, it is to be appreciated that aspects of the present inventive subject matter are also amenable to other like applications.

### BACKGROUND

As is known in the art, an SMR service is typically used by an organization to allow individuals within the particular organization to communicate with one another. For example, often first responders (e.g., police departments, fire departments, ambulance services, etc.), military (e.g., army, air force, national guard, coast guard, navy, marines, etc.) and/or various private or government agencies (e.g., the Red Cross, the Federal Emergency Management Agency (FEMA), etc.) use an SMR or other like service to permit the individuals within each organization to communicate with one another.

Generally, SMR and other similar mobile radio services (e.g., Family Radio Service (FRS) and General Mobile Radio Service (GMRS)) provide a multi-channel “always on” or “instant” communication service. That is to say, typically there is no dial-up procedure; rather, it is always on and is activated instantly by pressing a button and talking. Typically, these radio services provide half-duplex communication (i.e., transmission in both directions, but only one direction at a time).

Commonly, two-way radios are employed to utilize SMR services. A two-way radio is simply a radio that can both transmit and receive, i.e., a transceiver. Two-way radios are generally available in mobile and base configurations. Mobile or portable two-way radios are often called walkie-talkies. They usually take the form of a radio handset and include a button which is pressed or pushed to transmit and/or talk. Generally, within an organization, individuals in the field are equipped with walkie-talkies so that they may communicate with one another while being able to freely move about. Typically, an organization also employs a base two-way radio that remains stationary and is situated at a central and/or convenient location, e.g., a dispatch location, the organization's headquarters, a command post, etc. Often, the base radio is manned by a dispatcher, commander or other individual that coordinates and/or oversees movements and/or operations of the individuals in the field.

While SMR services are generally useful, there are some limitations and/or drawbacks that are particularly evident in certain circumstances. For example, different organizations using different radio services can have difficulties communicating with one another. More specifically, the channel assignments, frequencies and/or protocols used in connection with a first SMR service employed by a first organization may be different from the channel assignments, frequencies and/or protocols used in connection with a second SMR service employed by second organization. Accordingly, a first individual from the first organization can experience difficulty communicating with a second individual from the second organization, because the first individual's radio equipment (e.g., the first individual's walkie-talkie) is configured to operate with and/or utilize the first SMR service, while the second individual's radio equipment (e.g., the second individual's walkie-talkie) is configured to operate with and/or utilize the second SMR service.

The foregoing lack of interoperability is particularly troubling in times of natural disaster or other like catastrophes. In these instances, an organization from outside the effected geographic area may send aid in the form of emergency workers or other manpower. However, the individuals from the outside organization are often still provisioned with the radio equipment from their home region, and the radio equipment normally used by the outside organization may not be interoperable with the SMR service or services employed by local organizations. Additionally, because of the disaster or catastrophe, members of one organization within the effected geographic area may wish to aid another organization within the effected geographic area. However, the individuals from the second organization are often still provisioned with the radio equipment unique to their organization, and the radio equipment normally used by the second organization may not be interoperable with the SMR service or services employed by first organization.

One option to address the lack of interoperability is to have all the organizations use the same mobile radio service. This option, however, can be impractical. First, it can result in an overload of communication on the service in a given location as additional traffic is generated from multiple organizations competing for bandwidth. Second, many organizations switching to the common service may have to upgrade or change their radio equipment, which can be an undesirable expense. Another option is to equip organizations with a complete set of programmable radios that can be selectively configured or programmed to operate with and/or utilize a variety of different mobile radio services. Again, however, the added expense of providing such upgraded equipment all at once may be considered undesirable. In short, heretofore there has been lacking a suitable apparatus and/or method to provide interoperability and/or communication between different mobile radio services without altering all the radio equipment currently being employed by the respective organizations using different mobile radio services.

Accordingly, a new and improved apparatus and/or method for providing interoperability and/or communication between mobile radio services is disclosed that overcomes the above-referenced problems and others.

### SUMMARY

In accordance with one embodiment, a method of bridging mobile radio services is provided. The method includes: establishing communication with a first portable two-way radio via a first mobile radio service; receiving traffic from the first portable two-way radio via the first mobile radio service; converting the received bearer traffic into a designated format; and, routing the traffic to a selected destination.

In accordance with another embodiment, a system for bridging mobile radio services includes: means for establishing communication with a first portable two-way radio via a first mobile radio service; means for converting traffic received from the first portable two-way radio via the first mobile radio service into a designated format; and, means for routing the traffic to a selected destination.

In accordance with another embodiment, a system for bridging mobile radio services includes: a first base two-way radio provisioned to operate using a first mobile radio service having a first communication protocol; a second base two-way radio provisioned to operate using a second mobile radio service having a second communication protocol; and, a bridge operatively connected to the first and second base radios, the bridge normalizing traffic passing therethrough into a common communication protocol. Suitably, the first base radio is equipped to convert traffic from the common communication protocol into the first communication protocol, and the second base radio is equipped to convert traffic from the common communication protocol into the second communication protocol.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a block diagram illustrating an exemplary approach for bridging mobile radio services that embodies aspects of the present inventive subject matter.

FIG. 2 is a block diagram illustrating an exemplary base facility suitable for practicing aspects of present inventive subject matter.

### DETAILED DESCRIPTION

For clarity and simplicity, the present specification shall refer to structural and/or functional elements, entities and/or facilities, relevant communication standards, protocols and/or services, and other components and features that are commonly known in the telecommunications art without further detailed explanation as to their configuration or operation except to the extent they have been modified or altered in accordance with and/or to accommodate the embodiment(s) presented herein.

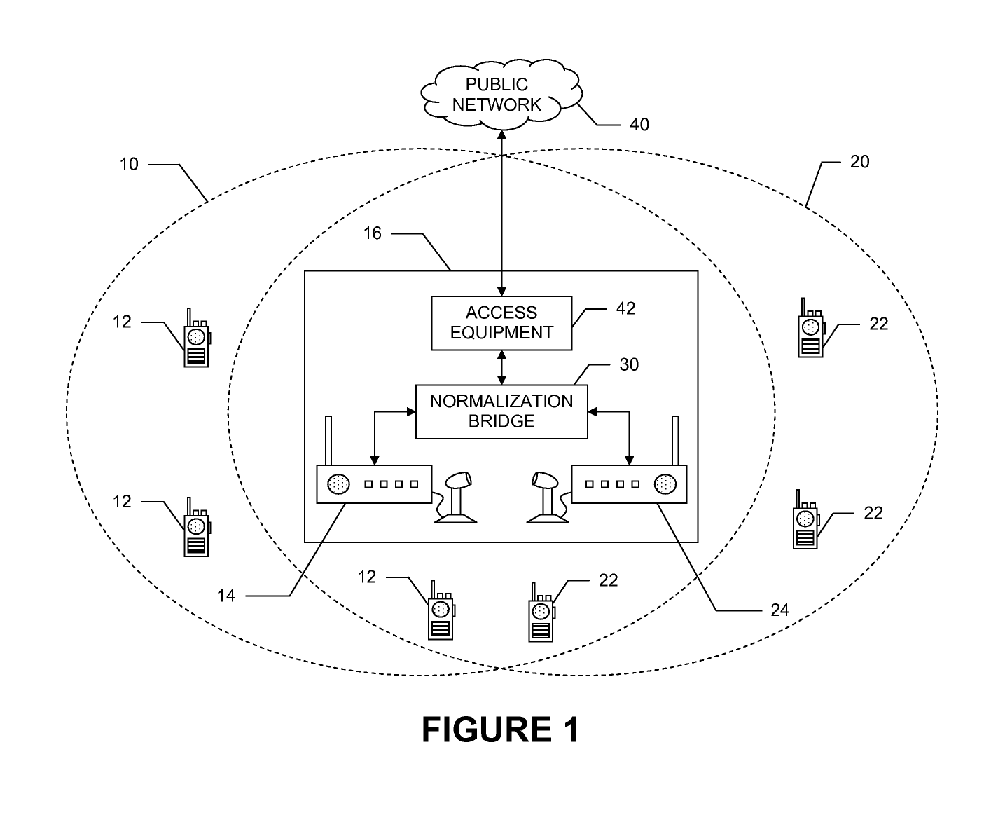

With reference to FIG. 1, a first mobile radio service (e.g., employed by a first organization) is indicated generally by reference numeral 10 and a second mobile radio service (e.g., employed by a second organization) is indicated generally by reference numeral 20. Suitably, the radio services are SMR services and the organizations are first responders, military organizations or other private or government agencies. Suitably, as shown, the SMR services overlap at least partially in the same geographic region. Optionally, one of the organizations (e.g., the first organization) is local or native to a geographic region in which it is operating, while the other organization (e.g., the second organization) is visiting from outside or is otherwise foreign to the geographic region in which it is operating, or is another local organization that does not normally inter-work with the first organization at this level. For purposes of the present example, the first and second mobile radio services 10 and 20 are different from one another. For example, at least one of the channel assignments, frequencies and/or protocols used by one of the mobile radio services is different from the channel assignments, frequencies and/or protocols used by the other mobile radio service.

Suitably, one or more individuals from the first organization are equipped with walkie-talkies or other like mobile or portal two-way radios 12 that are configured to operate with and/or utilize the first mobile radio service 10. Additionally, one or more individuals from the second organization are similarly equipped with walkie-talkies or other like mobile or portal two-way radios 22 that are configured to operate with and/or utilize the second mobile radio service 20. As shown, the first organization also employs a base two-way radio 14 that is configured to operate with and/or utilize the first mobile radio service 10. Suitably, the base radio 14 is situated at a convenient location or facility 16, e.g., a dispatch center, an organization headquarters, a command post, etc. For example, as shown, the facility 16 is located in the overlapping region of the first and second mobile radio services 10 and 20. Optionally, the facility 16 is also provided a base two-way radio 24 that is configured to operate with and/or utilize the second mobile radio service 20. Accordingly, individuals (e.g., from the first organization) are able to communicate among themselves via the mobile radio service 10 using radios 12 and 14 in the usual manner. Likewise, individuals (e.g., from the second organization) are able to communicate among themselves via the mobile radio service 20 using radios 22 and 24 in the usual manner.

As shown in FIG. 1, the facility 16 is also provisioned and/or equipped with a normalization bridge 30 that is operatively interconnected between the base radios 14 and 24. Suitably, the normalization bridge 30 encodes, translates and/or otherwise converts or transforms communications passing therethrough into a common format and/or protocol. In one embodiment, the common format is optionally an Internet Protocol (IP) format, e.g., that is compatible with a Next Generation Network (NGN) employing an IP Multimedia Subsystem (IMS) architecture. In the illustrated embodiment, the bridge 30 is implemented as a separate hardware component, e.g., running suitable software to format and/or convert or transform communications from the radios 14 and 24 into the common protocol. However, it is to be appreciated that optionally either one or both of the base radios 14 and 24 may have their own bridge 30 or a similar component or functional equivalent incorporated therein. In either case, suitably, the base radio 14 is provisioned, equipped and/or otherwise adapted to decode, translate and/or otherwise convert or transform communications received in the common format and/or protocol produced by the normalization bridge 30 into the format and/or protocol used by the first mobile radio service 10. Likewise, the base radio 24 is also suitably provisioned, equipped and/or otherwise adapted to decode, translate and/or otherwise convert or transform communications received in the common format and/or protocol produced by the normalization bridge 30 into the format and/or protocol used by the second mobile radio service 20.

In one embodiment, the normalization bridge 30 employs any suitable VoIP (Voice over IP) processing or other like technique to transform or convert voice communications or traffic received from the radios 14 and/or 24 into the common IP format. Likewise, the radios 14 and 24 employ similar VoIP processing and/or other like techniques to transform or convert the IP traffic back into formats compatible with their respective mobile radio services 10 and 20.

In operation, when a first individual equipped with one of the radios 22 (e.g., an individual from the second organization) wants to communicate with a second individual equipped with one of the radios 12 (e.g., an individual from the first organization), the first individual simply uses their radio 22 to contact the base radio 24 in the usual manner via the second mobile radio service 20. Optionally, the facility 16 is manned by one or more facilitators or other individuals (e.g., a dispatcher, a commander, a facility manager, etc.). Suitably, the facilitator uses the radio 24 to answer the radio transmission or communication received from the first individual. Having established communications via the second mobile radio service 20, the first individual may tell or otherwise communicate to the facilitator the identity of the second individual that is being sought. Suitably, the facilitator then uses the radio 14 to contact the second individual via the first mobile radio service 10 in the usual manner. Having established communications with the second individual via the first mobile radio service 10, the facilitator then patches or bridges the two communication sessions together through the normalization bridge 30. For example, after the initial contact, the facilitator may tell the first individual to switch their radio 22 to a particular channel (e.g., channel X) on the second mobile radio service 20. Likewise, when the facilitator contacts the second individual, the facilitator may tell the second individual to switch their radio 12 to a particular channel (e.g., channel Y) on the first mobile radio service 10. Suitably, the facilitator may then operatively connect channel X from the base radio 24 and channel Y from the base radio 14 to a common channel on the normalization bridge 30.

Accordingly, outgoing traffic transmitted from the radio 22 on channel X is received by the radio 24 in the usual manner via the second mobile radio service 20. The traffic on channel X is in turn routed from the radio 24 to the bridge 30 where it is normalized, i.e., formatted and/or converted into a common protocol for further transmission. For example, the bridge 30 optionally packetizes the traffic and/or transforms it into an IP compatible format. The converted traffic (e.g., in IP format) is in turn routed to the radio 14. The radio 14 in turn reconstitutes or otherwise converts the traffic into the format and/or protocol used by the first mobile radio service 10, and transmits the same on channel Y to the radio 12 in the usual manner via the first mobile radio service 10. In this way, the radio 12 receives the traffic from radio 22.

Similarly, outgoing traffic transmitted from the radio 12 on channel Y is received by the radio 14 in the usual manner via the first mobile radio service 10. The traffic on channel Y is in turn routed from the radio 14 to the bridge 30 where it is normalized, i.e., formatted and/or converted into a common protocol for further transmission. For example, the bridge 30 optionally packetizes the traffic and/or transforms it into an IP compatible format. The converted traffic (e.g., in IP format) is in turn routed to the radio 24. The radio 24 in turn reconstitutes or otherwise converts the traffic into the format and/or protocol used by the second mobile radio service 20, and transmits the same on channel X to the radio 22 in the usual manner via the second mobile radio service 20. In this way, the radio 22 receives the traffic from radio 12.

Suitably, the bridge 30 is equipped with one or more distinct channels. As can be appreciated, a multi-channel bridge 30 allows for a plurality of channels from the first mobile radio service 10 to be bridged to the second mobile radio service 20 at the same time.

In a typically disaster relief scenario, the advantage of the foregoing system can be appreciated. For example, when a foreign or visiting or other local organization of first responders first enter the disaster area to provide aid, they optionally give the facility 16 a radio (e.g., like the base radio 24) which is already configured to work with their normal mobile radio service (e.g., like the mobile radio service 20). Alternately, the entering first responders simply provide the facility 16 with a set of parameters so that an existing base radio at the facility 16 may be configured or programmed to work with their normal mobile radio service. Assuming the facility 16 is local or native to the disaster area, it is typically already equipped with a radio (e.g., like the base radio 14) that is configured to work with the mobile radio service used by a local or native organization of first responders (e.g., like the mobile radio service 10).

As can be appreciated, in the foregoing approach, neither the radios 12 nor the radios 22 have to be altered to communicate with one another. That is to say, once the radio 24 is provisioned within the facility 16, individuals equipped with the radios 12 (e.g., individuals from a local organization of first responders) are able to communicate with individuals equipped with the radios 22 (e.g., individuals from a foreign organization of first responders) regardless of the mobile radio service normally used by either organization. By normalizing the communication traffic to a common format or protocol (e.g., IP) at the base facility 16, interoperability is achieved regardless of the communication format and/or protocols used by the different mobile radio services. Accordingly, individuals from the local organization can continue to use their normally issued radio equipment, and individuals from the visiting organization can also continue to use their normally issued radio equipment.

An additional benefit to using a common format or protocol such as IP is the ability to bridge mobile radio services to one or more public telecommunication networks such as the Internet, the public switched telephone network (PSTN) and/or wireless telecommunications networks. For example, as illustrated in FIG. 1, the bridge 30 is operatively connected to a public network 40. Accordingly, communications received by the facility 16 from the radios 12 and/or 22 can be extended to anyone served by or otherwise accessible through the public network 40. Likewise, the facility 16 can extend communications received from the public network 40 to the mobile radios 12 and/or 22 via the respective mobile radio services 10 and 20. That is to say, individuals equipped with the radios 12 and/or 20 can be connected through the facility 16 to anyone that is normally accessible over the public network 40. Suitably, the facility 16 is provisioned with network assess equipment 42 to access the network 40. For example, the access equipment 42 optionally provides access to the Internet via any suitable Internet connection. Access to the PSTN and/or wireless telephone networks is suitably achieved via an IP gateway, which is optionally incorporated within the access equipment 42 or alternately elsewhere provisioned in the network 40. In the illustrated embodiment, the network access equipment 42 is implemented as a separate component. However, it is to be appreciated that the access equipment 42 or a similar component or its functional equivalent is optionally incorporated in the bridge 30. In one embodiment, the access equipment 42 optionally includes a telephone (e.g., a VoIP phone such as a hardphone or a softphone running on a computer or other suitable platform) or a multimedia end user device or other like equipment or components for sending and receiving communications over the network 40.

In operation, when a first individual equipped with one of the radios 12 or 22 wants to communicate with a second individual accessible over the public network 40, the first individual simply uses their radio 12 or 22 to contact the respective base radio 14 or 24 in the usual manner via the first or second mobile radio service 10 or 20. Suitably, a facilitator uses the radio 14 or 24 as the case may be to answer the radio transmission or communication received from the first individual. Having established communications via the respective mobile radio service 10 or 20, the first individual tells or otherwise communicates to the facilitator, e.g., the telephone number or IP address of the second individual that is being sought. Accordingly, the facilitator then uses the access equipment 42 in the usual manner to place a call to or establish a session with the designated party over the public network 40. Having established a connection with the second individual over the network 40 via the access equipment 42, the facilitator then patches or bridges the two communication sessions together through the normalization bridge 30. For example, after the initial contact, the facilitator may tell the first individual to switch their radio 12 or 22 to a particular channel (e.g., channel Z) on the first or second mobile radio service 10 or 20. Suitably, when the facilitator establishes a connection with the second individual over the network 40, the facilitator may then operatively connect channel Z from the respective base radio 14 or 24 and the call or session established via the access equipment 42 to a common channel on the normalization bridge 30.

Accordingly, outgoing traffic transmitted from the radio 12 or 22 on channel Z is received by the respective radio 14 or 24 in the usual manner via the first or second mobile radio service 10 or 20 as the case may be. The traffic on channel Z is in turn routed from the radio 14 or 24 to the bridge 30 where it is normalized, i.e., formatted and/or converted into a common protocol for further transmission. For example, the bridge 30 optionally packetizes the traffic and/or transforms it into an IP compatible format. The converted traffic (e.g., in IP format) is in turn routed through the connection established with the access equipment 42 over the network 40 to the second individual. In this way, the second individual accessible via the network 40 receives the traffic from radio 12 or 22. Of course, depending upon the type of network connection employed by the second individual, the traffic routed over the network 40 is carried in any suitable manner. For example, as appropriate, one or more IP gateways or other like network elements are employed to transition traffic between packet-switched and circuit-switched networks.

In another example, when a first party wishes to contact a second party equipped with one of the mobile radios 12 or 22, they may do so using the network 40. Suitably, the first party simply places a call or establishes a session in the usual manner over the network 40 to a telephone number or IP address designated for or assigned to the facility 16 and/or the access equipment 42. Suitably, the facilitator uses the access equipment 42 to answer the call received from the calling party or to otherwise establish a session or connection with the first party over the network 40. Having established a connection with the first party over the network 40, the first party tells or otherwise communicates to the facilitator the identity of the second party that is being sought. Suitably, the facilitator then uses one of the radios 14 or 24 to contact the second individual via the first or second mobile radio service 10 or 20 in the usual manner. Having established communications with the second individual via the first or second mobile radio service 10 or 20, the facilitator then patches or bridges the two communication sessions together through the normalization bridge 30. For example, after contacting the second party, the facilitator may tell them to switch their radio 12 or 22 to a particular channel (e.g., channel W) on the first or second mobile radio service 10 or 20. Suitably, the facilitator may then operatively connect channel W from the respective base radio 14 or 24 and the call or session established via the access equipment 42 to a common channel on the normalization bridge 30.

Suitably, when traffic is received from the network 40, it is already in IP format, e.g., having been received over the Internet. Alternately, the access equipment 42 and/or bridge 30 convert or transform the traffic into the common IP format. The traffic is in turn routed to the appropriate radio 14 or 24. The radio 14 or 24 in turn reconstitutes or otherwise converts the traffic into the format and/or protocol used by the first or second mobile radio service 10 or 20, and transmits the same on channel W to the radio 12 or 22 in the usual manner via the first or second mobile radio service 10 or 20. In this way, the radio 12 or 22 receives the traffic from the network 40.

As can be appreciated with the foregoing approach, individuals in the field equipped with radios 12 and/or 22 have improved ability to communicate with other individuals that may not be equipped to utilize the mobile radio services 10 and/or 20. For example, a first individual using one of the radios 12 or 22 is able to connect with a second individual accessible via the network 40 regardless of that second individual's geographic location, hence potentially extending the effective communication range of the first individual beyond the normal transmission range of the radio 12 or 22. Additionally, two base facilities (e.g., like the facility 16) may optionally connect with one another over the network 40, thereby allowing individuals in the field (e.g., equipped with walkie-talkies) that are located in different relatively remote theaters of operation to communicate with one another, even though those theaters of operation may be farther apart than the conventional transmission range of their walkie-talkies.

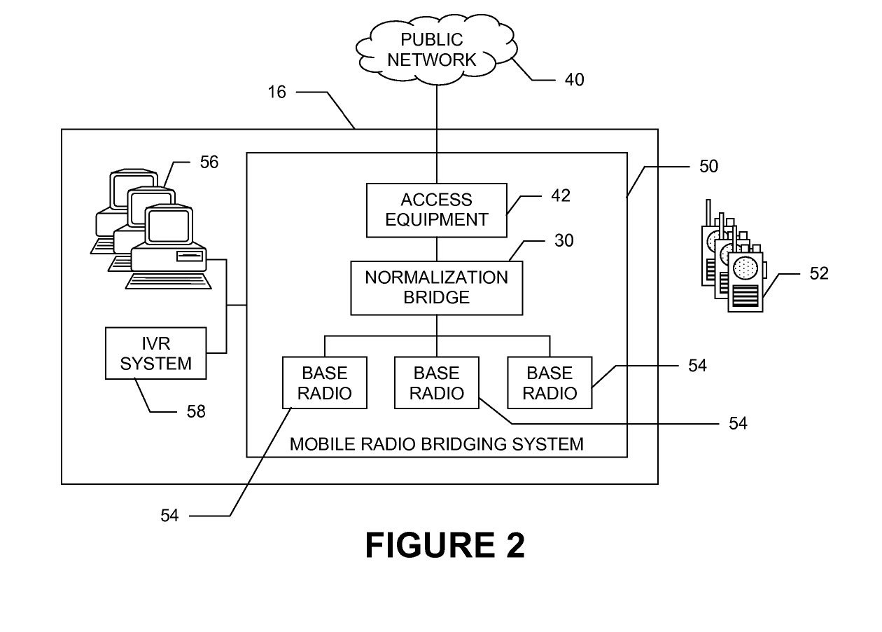

With reference to FIG. 2, the base facility 16 is optionally provisioned with a mobile radio service bridging system 50. Suitably, the facility 16 is a Public Safety Answering Point (PSAP) into which the mobile radio service bridging system 50 is integrated. In another embodiment, the system 50 is integrated into a facility such as an agency headquarters, operations center or dispatch facility, e.g., such as a highway patrol or police office or a fire station or an ambulance dispatch center, etc. Alternately, the system 50 is equipped in a facility that is a mobile command center, e.g., implemented within a trailer that is transported to the scene of a disaster or other relief effort.

Generally, the system 50 includes: a collection of radios, interconnecting hardware and processing software that is used to bridge together different radio services and/or public telecommunication networks that would otherwise lack interoperability. By transforming or converting the communications or traffic into a common communication protocol, the system 50 is able to connect together those individuals equipped with different radios provisioned to work with different mobile radio services, as well as connecting those radio-equipped individuals to other individuals accessible via standard telecommunication networks such as the Internet, PSTN, etc.

In FIG. 2, the system 50 includes the normalization bridge 30 which is operatively connected to the network 40 via access equipment 42. As shown, the bridge 30 is also operatively connected to one or more base two-way radios 54 that operate and/or function essentially the same as the base radios 14 and 24. Suitably, each radio 54 is provisioned and/or otherwise programmable to work with a separate and/or distinct mobile radio service. Accordingly, one or more mobile two-way radios 52 that operate and/or function essentially the same as the radios 12 and 22 may communicate with the system 50 and/or communicate with one another via the system 50. Again, suitably, the different radios 52 are provisioned and/or programmed to work with separate and/or distinct mobile radio services.

Suitably, the system 50 is operated and/or administered by one or more individuals working from one or more workstations 56. For example, each workstation 56 is optionally equipped with a monitor or display, a graphic user interface (GUI), input/output devices (e.g., a keyboard, a mouse, etc.), a telephone headset, etc. Accordingly, from the workstation 56, a facilitator is able to receive and/or place calls over the network 40, establish IP or other like network sessions over the network 40, operate the radios 54 and/or use the radios 54 to communicate with radios 52 via one or more mobile radio services, and/or interconnect selected individuals with one another via the system 50 (i.e., selectively route particular traffic to and/or from the radios 54 and/or network 40 through the bridge 30).

In one suitable embodiment, the system 50 is optionally operated and/or controlled by an interactive voice response (IVR) system 58 to minimize the amount of manual intervention on the part of the facilitators. For example, when the system 50 is accessed (e.g., via a radio transmission from one of the radios 52 received by one of the base radios 54 or via the network 40), the IVR system 58 suitably uses synthesized voice prompts or the like to solicited input from the accessing party. Using voice recognition, the IVR system 58 recognizes the voice input from the accessing party and operates the bridging system 50 to complete the appropriate connection, i.e., to interconnect designated individuals and/or properly route selected communications through the bridge 30. That is to say, the IVR system 58 acts as the facilitator, e.g., in the same manner described above with reference to FIG. 1. As described above, suitably, the bridge 30 normalizes the traffic passing therethrough, e.g., converting and/or formatting it into a common communication protocol such as an IP format.

Suitably, dual-tone multi-frequency (DTMF) signaling is also optionally used. For example, an individual in the field using a walkie-talkie or other like portal two-way radio 52 to access the system 50 is optionally provided a separate DTMF tone generating device that is manually placed over the mouthpiece of the radio 52 when the user desires to transmit DTMF tones to the system 50, or alternately a DTMF generating device is optionally built into the radio 52. Accordingly, when the user wish to place a call to an individual over the network 40, the walkie-talkie user contacts one of the base radios 54 in the usual manner, e.g., using a designated channel (e.g., channel M) on the particular mobile radio service that is employed by the radio 54 and the user's walkie-talkie 52. In response, the system 50 plays or sends out a tone via the radio 54 on channel M of the mobile radio service being used. The tone is received by the user's walkie-talkie 52 indicating and/or prompting the user to enter the telephone number that they desire to call with their DTMF generating device. The entered DTMF signal or tones are in turn received by the system 50, which uses them to place a call over the network 40, e.g., using the access equipment 42. This call and channel M from the radio 54 are then patched together through the bridge 30.

Generally, from time to time an organization will update and/or replace its radio equipment. As mobile radios (such as the radios 52) are replace, the newer radios may well have additional capabilities beyond mere voice communications, e.g., the ability to access different types of media. By using an IP format as the common protocol at the facility 16, communication between radios with different capabilities is facilitated. In one embodiment, if the radios 52 are suitably equipped, the system 50 optionally provides an Internet type of connection directly with the radios 52. For example, such an interface optionally supports a more automated experience, and also allows the radios 52 to optionally access websites, short message services (SMS), instant messaging, e-mail and/or other types of media in addition to voice communications. Suitably, in such a case, each radio 52 is assigned its own IP address for identification purposes. Of course, as can be appreciated, other sophisticated telephony style features may likewise be made available to users of the radios 52, e.g., such as conference calling, call forwarding, etc.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method of bridging mobile radio services, said method comprising:
(a) establishing communication with a first portable two-way radio via a first mobile radio service;
(b) receiving traffic from the first portable two-way radio via the first mobile radio service;
(c) converting the received traffic into a designated format; and,
(d) routing the traffic to a selected destination.

2. The method of claim 1, wherein step (d) comprises:
establishing communication with a second portable two-way radio via a second mobile radio service;
converting the traffic from the designated format into a format compatible with the second mobile radio service; and,
transmitting the traffic to the second portable two-way radio via the second mobile radio service.

3. The method of claim 2, wherein the designated format is an Internet Protocol (IP) format.

4. The method of claim 1, wherein step (d) comprises:
establishing a connection with the destination via a telecommunications network; and,
transmitting the traffic to the destination over the network.

5. The method of claim 4, wherein the designated format is an Internet Protocol (IP) format and the network is the Internet.

6. A system for bridging mobile radio services, said system comprising:
means for establishing communication with a first portable two-way radio via a first mobile radio service;
means for converting traffic received from the first portable two-way radio via the first mobile radio service into a designated format; and,
means for routing the traffic to a selected destination.

7. The system of claim 6, wherein said means for routing comprises:
means for converting the traffic from the designated format into a format compatible with a second mobile radio service; and,
means for transmitting the traffic to a second portable two-way radio via the second mobile radio service.

8. The system of claim 7, wherein the designated format is an Internet Protocol (IP) format.

9. The system of claim 6, wherein said means for routing comprises:
means for establishing a connection with the destination via a telecommunications network; and,
means for transmitting the traffic to the destination over the network.

10. The system of claim 9, wherein the designated format is an Internet Protocol (IP) format and the network is the Internet.

11. A system for bridging mobile radio services, said system comprising:
a first base two-way radio provisioned to operate using a first mobile radio service having a first communication protocol;
a second base two-way radio provisioned to operate using a second mobile radio service having a second communication protocol; and,
a bridge operatively connected to the first and second base radios, said bridge normalizing traffic passing therethrough into a common communication protocol;
wherein said first base radio is equipped to convert traffic from the common communication protocol into the first communication protocol, and the second base radio is equipped to convert traffic from the common communication protocol into the second communication protocol.

12. The system of claim 11, wherein the common communication protocol is Internet Protocol (IP).

13. The system of claim 11, further comprising:
access equipment operatively connected to the bridge, said access equipment providing access to a telecommunications network to which the access equipment is also operatively connected.

14. The system of claim 11, further comprising:
a workstation which a facilitator uses to operate the system.

15. The system of claim 11, further comprising:
an interactive voice response system which is used to operate the system.

16. The system of claim 11, wherein a selected channel from the first base radio and a selected channel from the second base radio are connectable through the bridge.
